(19) United States
(12) Patent Application Publication
(10) Pub. No.: US 2025/0274538 A1
(43) Pub. Date: Aug. 28, 2025

(54) CUSTOMIZABLE USER DATAGRAM PROTOCOL (UDP) PAYLOAD HASHING

(71) Applicant: Arista Networks, Inc., Santa Clara, CA (US)

(72) Inventors: Chen Jia Jang, Burnaby (CA); Thomas Benjamin Emmons, Sunnyvale, CA (US)

(73) Assignee: Arista Networks, Inc., Santa Clara, CA (US)

(21) Appl. No.: 18/589,205

(22) Filed: Feb. 27, 2024

(51) Int. Cl. H04L 69/22; H04L 69/18

(52) U.S. Cl. CPC H04L 69/22; H04L 69/18

(57) ABSTRACT

Particular embodiments described herein provide for a system, an apparatus, and a method that includes receiving a packet; parsing a header of the packet to determine a protocol type for the packet and to extract information from the packet. The method also includes matching a configured protocol field in the header of the packet to a specified value; determining a byte range for the packet using the specified value; and creating entropy for the packet by using data from the byte range. In more particular embodiments, the protocol type is identified by a destination port in the header, and wherein the protocol type is user datagram protocol (UDP) for the packet. In specific embodiments, the method includes accessing a database that includes a plurality of destination ports; and determining which bytes from the packet are included in the hash to create the entropy for the packet.

### TECHNICAL FIELD

This disclosure relates in general to the field of computing and/or networking and, more particularly, to a system, an apparatus, and a method to enable customizable user datagram protocol (UDP) payload hashing.

### BACKGROUND

In computer networking, ‘link aggregation’ can refer to the general principle of combining (aggregating) multiple network connections in parallel by various methods. Link aggregation increases total throughput beyond what a single connection could sustain and, further, provides redundancy in which all but one of the physical links may fail without losing connectivity. A link aggregation group (LAG) is the combined collection of physical ports. Link aggregation offers an inexpensive way to enable a high-capacity backbone network that transfers multiple times more data than any single port or device can deliver. Link aggregation also allows the network's backbone speed to grow incrementally, as demand on the network increases, without having to replace an entire architecture and deploy new hardware.

Network architects can implement aggregation at any of the lowest three layers of the OSI model. Examples of aggregation at layer 1 (physical layer) include power line (e.g., IEEE 1901) and wireless (e.g., IEEE 802.11) network devices that combine multiple frequency bands. OSI layer 2 (data link layer, e.g., Ethernet frame in LANs or multi-link PPP in WANs, Ethernet MAC address) aggregation typically occurs across switch ports, which can be either physical ports or virtual ones managed by an operating system. Aggregation at layer 3 (network layer) in the OSI model can use round-robin scheduling, hash values computed from fields in the packet header, or a suitable combination of these methods.

In general, hashing can be performed in packet parser hardware. Packet parser hardware should be programmed to suitably handle protocol headers. Parser programming is typically done by writing parser code, which is compiled into a microcode (e.g., a set of hardware configurations). Aside from hardware resource considerations, adding new protocols to parser code consumes valuable engineering time.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a system to enable customizable user datagram protocol (UDP) payload hashing, in accordance with an embodiment of the present disclosure;

FIG. 2 is a simplified block diagram of a particular implementation of a packet parser engine to enable customizable UDP payload hashing, in accordance with an embodiment of the present disclosure;

FIG. 3 is a simplified block diagram of a possible implementation of a packet entropy engine for a system that enables customizable UDP payload hashing, in accordance with an embodiment of the present disclosure;

FIG. 4 is a simplified block diagram of a possible implementation of an entropy header engine for a system that enables customizable UDP payload hashing, in accordance with an embodiment of the present disclosure;

FIG. 5 is a simplified block diagram of a portion of a UDP message packet for enabling customizable UDP payload hashing, in accordance with an embodiment of the present disclosure;

FIG. 6 is a simplified block diagram illustrating example details of a portion of a packet header to enable customizable UDP payload hashing, in accordance with an embodiment of the present disclosure;

FIG. 7 is an example flowchart illustrating operations to enable customizable UDP payload hashing in accordance with an embodiment of the present disclosure;

FIG. 8 is an example flowchart illustrating operations to enable a customizable payload hashing for various different types of protocols in accordance with an embodiment of the present disclosure; and

FIG. 9 is an example flowchart illustrating operations to enable customizable payload hashing using a list provisioned within a database in accordance with an embodiment of the present disclosure.

The FIGURES of the drawings are not necessarily drawn to scale, as their dimensions can be varied without departing from the scope of the present disclosure.

### DETAILED DESCRIPTION

The following detailed description sets forth examples of apparatuses, methods, and systems relating to enabling customizable user datagram protocol (UDP) payload hashing in accordance with an embodiment of the present disclosure. Features such as structure(s), function(s), and/or characteristic(s), for example, are described with reference to one embodiment as a matter of convenience; various embodiments may be implemented with any suitable one or more of the described features.

### Overview

In an example, a system and a method can provide a generic payload hashing mechanism for any protocol that has a next protocol field, and which can be especially valuable for UDP-based protocols. For example, in the UDP protocol, the next protocol field is the destination port field, in the IP protocol, the next protocol field is the IP next protocol, in Ethernet protocol, the next protocol field is the ethernet type (e.g., EtherType, which is a two-octet field in an Ethernet frame), etc. A user or network operator can readily configure the system to support different protocols at run time. The term ‘next protocol field’ is an expansive, broad term that includes any portion of the header that can define what is provided, appended, encapsulated, or otherwise included inside that header (e.g., UDP destination port in many examples disclosed herein).

In a given ASIC chip, there is a parser, and the parser determines the identity of the packet when it is received. Once a determination is made about the type of packet (e.g., based on a next protocol field of the packet), the system of the present disclosure determines which bytes from the packet are to be included in a hash to create entropy for the packet. Note that the packet parser is a limited hardware resource in which every additional protocol added to the parser uses up some of its resources. The system of the present disclosure allows the same piece of the parser's resource to be dynamically assigned to manage different protocols. The system further enables new protocols to be accommodated without additional engineering time because the system does not need to be redesigned to be able to handle each new protocol.

To configure the generic payload hashing mechanism for UDP packets, the system can select a generic UDP-based protocol that is identified by a destination port. The system also selects a byte range or ranges in the payload of a UDP packet that will be used in a hash to create entropy for the UDP packet. The header fields of the generic UDP-based protocol can be defined to be byte1 . . . byte32, where the field byte1 corresponds to the first byte of the payload, byte2 corresponds to the second byte of the payload, and so forth. This allows each byte of the payload to be included or excluded in the hash at run time. At run time, based on the user specified destination port and payload byte ranges specified by the user, the generic UDP-based protocol is set (e.g., for packets with the user specified destination port, the system understands how to use the generic UDP-based protocol), and the hashing control for the byte1-byte32 fields are set. For example, the user may specify “udp payload dst-port 4791 payload bytes 5-7”, to hash on payload bytes 5-7 of the UDP protocol identified by destination port 4791. In some examples, the payload byte range can include non-consecutive bytes.

The protocols for UDP packets are identified by the UDP destination port in the UDP header. Based on the protocols, the bytes are exposed to allow the user to elect to hash the bytes they want to use when creating entropy for the packet. This allows the same piece of resource allocated hardware to be used to support a variety of different protocols and simultaneously avoids the problem that separate parser code should be written to handle each protocol, which is to be included in a hash that is used to create entropy for a packet. Entropy refers to a number or a value associated with a packet in a specific flow. Every packet with the specific flow should produce the same entropy, and packets with a different flow should produce a different entropy.

### Example Systems, Apparatuses, and Methods

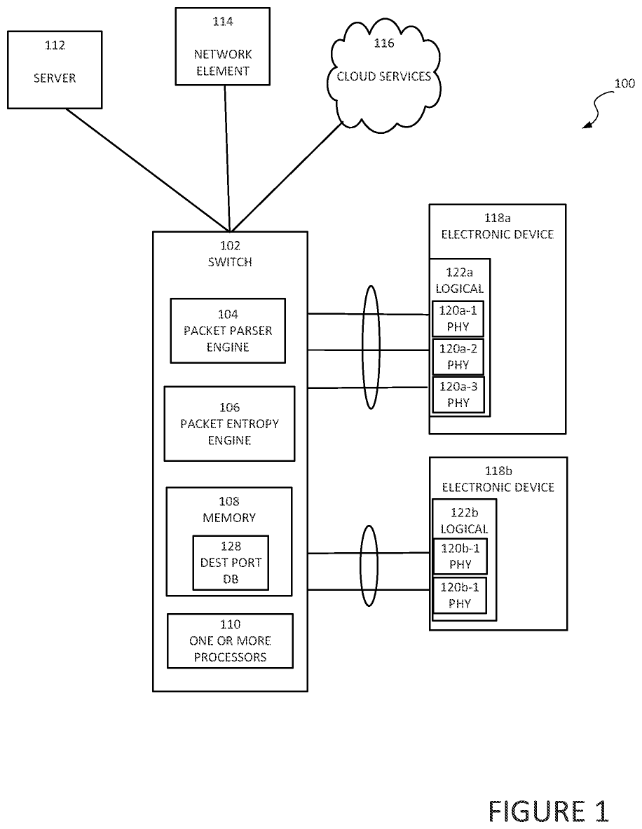

FIG. 1 is a simplified block diagram of a particular non-limiting implementation of a system 100 to enable customizable UDP payload hashing. Referring to FIG. 1, the system 100 can include a switch 102. The switch 102 can include a packet parser engine 104, a packet entropy engine 106, a memory 108, and one or more processors 110. The memory 108 can include a destination port database 128. The destination port database can include a list of destination ports (physical and/or virtual) that have been identified by the user to receive packets that are enabled with the customizable UDP payload hashing discussed herein. When a packet is received that is bound for a destination port in the destination port database 128, the system can use offset bytes in the header field of the packet to determine the user configured payload byte range of the packet. The user configured payload byte range is the location of data to be used in a hash for a specific packet, where the hash can be used to determine the entropy for the specific packet. In some examples, the offset bytes can be configured at run time. Also, the user configured byte range of the packet can include non-consecutive bytes.

The switch 102 can be in communication with a server 112, a network element 114, and a cloud services 116. The switch 102 can also be in communication with one or more electronic devices. For example, as illustrated in FIG. 1, the switch 102 is in communication with electronic device 118a and electronic device 118b. The electronic device 118a can include physical ports 120a-1, 120a-2, and 120a-3. The physical ports 120a-1, 120a-2, and 120a-3 can be grouped together in a logical port 122a, as is illustrated. The electronic device 118b can include physical ports 120b-1 and 120b-2. The physical ports 120b-1 and 120b-2 can be grouped together in a logical port 122b. The electronic devices 118a and 118b can be switches, routers, gateways, servers, or any other suitable network elements.

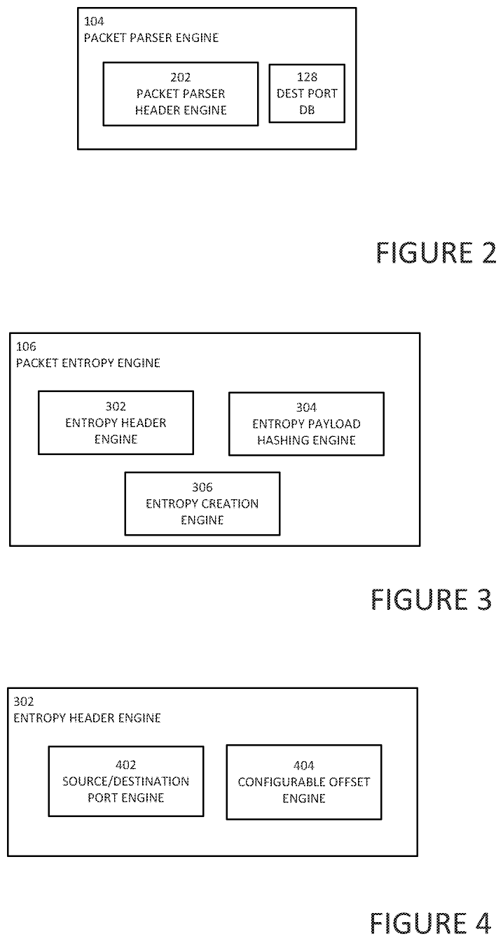

The packet parser engine 104 can be configured to parse (e.g., evaluate, inspect, analyze) packets received by the switch, determine the packet type, and extract information based on the packet type. Packet parsing is the first step in processing packets in devices such as network switches and routers. Packet parsing is necessary at points in the modern networking infrastructure to support packet classification and security functions, as well as for protocol implementation. The parsing of a packet provides a high-level way of describing formats of packet headers and rules for parsing these headers. Packets can be passed through the packet parser transparently, together with the extracted information to be processed by the switch 102. The packet parser engine 104 is described in more detail below in FIG. 2.

The packet entropy engine 106 can be configured to determine an entropy for a packet received by the switch 102. In the examples discussed below, entropy refers to a number (or the associated value) for a packet in any specific flow. Packets within a specific flow ideally produce the same entropy and, conversely, any packets associated with a different flow would thereby produce different entropies. All such packets would be routed across a network efficiently using the identified entropy. Such a paradigm allows packets of the same flow to follow the same path through the network. The entropy for packets in a flow can be appropriately identified from fields that vary across flows, but that are still the same or consistent in a specific flow such that all the packets in the associated flow produce the same entropy. The packet entropy engine 106 and its associated capabilities are described below in more detail in FIG. 3.

In an illustrative example, the system selects the generic UDP-based protocol that is identified by a destination port. For example, the user can select a first UDP destination port (e.g., the logical port 122a) as a destination port for a first flow of packets that use the generic UDP-based protocol and a second UDP destination port (e.g., the logical port 122b) as a destination port for a second flow of packets that use the generic UDP-based protocol. Note that the UDP destination port is not a physical or logical interface that the packet goes in and out of, but a number (e.g., 1-65535) in the UDP header. Because senders do not know which processes are active at any given moment, the UDP protocol uses destination protocol ports (or abstract destination points within a machine), identified by positive integers, to send messages to one of multiple destinations on a host.

For each destination port, the user or network operator selects a byte range (or ranges) in a UDP packet that will be used in a hash to create entropy for the UDP packet. In some examples, the byte range includes non-consecutive bytes. More specifically, the user can select a byte range of bytes 1, 2, and 6-11 for UDP packets in the first flow of packets with a destination of the first UDP destination port (e.g., the logical port 122a), and a byte range of bytes 4-9 for UDP packets in the second flow of packets with a destination of the second UDP destination port (e.g., the logical port 122b). In this example scenario, the header fields of the generic UDP-based protocol are byte1 . . . byte32 and the field byte1 corresponds to the first byte of the payload. In using such a process, at run time each byte of the payload is included or excluded in the hash.

In operation of an example flow, at run time, the switch 102 can receive a packet from the server 112, the network element 114, or cloud services 116. The packet is parsed by the packet parser engine 104 to determine the packet type and a destination port for the packet. After the destination port for the packet is determined and, if the destination port is in the destination port database 128, a byte range of the packet to be used in a hash for the entropy of the packet is determined. Based on the destination port and byte ranges specified by the user, the destination port for the generic UDP-based protocol packet is set, and the hashing control for the byte1-byte32 fields are also set. For example, if the destination port is the logical port 122a, then the byte range of bytes 1, 2, and 6-11 are used by the packet entropy engine 106 to create a hash, and the hash is used to determine the packet entropy for the packet. If the destination port is the logical port 122b, then the byte range of bytes 4-9 are used by the packet entropy engine 106 to create a hash, and the hash is used to determine the packet entropy for the packet.

It is to be understood that other embodiments and implementations of packet entropy engine 106 and packet parser engine 104 may be modified considerably, and additional structural changes may be made to the switch 102 without departing from the scope of the present disclosure. Substantial flexibility is provided by the system and methods disclosed herein in that any suitable arrangements and configurations may be provided without departing from the teachings of the present disclosure. For example, any of the aforementioned elements may be provided external to the identified switch 102, or provisioned in a proprietary element whose purposes include providing some variation of the customizable UDP payload hashing, as detailed herein.

For purposes of illustrating certain example techniques and processes of the architectures disclosed herein, some foundational information may be appropriate for providing a suitable context. Several prominent technological trends are currently afoot (e.g., more computing devices, more online video services, more Internet traffic, etc.), and these trends are changing the media delivery landscape. One important trend is associated with link aggregation. Link aggregation is the combining (aggregating) of multiple network connections in parallel by any of several methods. For example, the links can be combined or aggregated into a link aggregation group (LAG). A LAG is a standard that allows multiple physical links to be combined into one logical high-speed link.

Per flow hashing uses information in a packet as an input to a hash function ensuring that any specific flow would map to the same path. Hashing is an extremely useful technique for a variety of high-speed packet-processing applications in routers, switches, gateways, etc. For example, effective hashing of the packet helps to allow for equal cost multipath routing in switches, network load balancing in server clusters, per-flow statistics in switches (e.g., QoS, IDS), caching in cooperative CDNs and P2P file sharing, data partitioning in distributed storage services, and other users. In addition, hashing can be used to verify the integrity of a given piece of data. Since the hash generated is unique to the input data, it acts as a unique “fingerprint” of the input data. This makes a hash useful for verifying the integrity of data sent through insecure communication channels like the internet.

To fully utilize the capacity of the physical links, the packets on the logical link should be evenly distributed across the physical links. Network operators must balance traffic without impacting resources (e.g., wasting cycles by reordering Ethernet frames). Out-of-order TCP packets are especially burdensome in terms of their overhead. A blunt solution would be to send all frames associated with a particular session across the same link, regardless of their underlying characteristics. Alternatively, using L2 or L3 hashes based on the MAC or the IP addresses represents a typical solution for determining entropy. This can be achieved by computing a hash of the packet headers that identify the individual communication flows on the logical link, determine entropy for the packet using the hash, and distribute the packets across the physical links according to the entropy of the packet.

Generally, by way of example, on a family of switching ASICs, hashing is done in the packet parser hardware, and the packet parser would be programmed to manage protocol headers that are to be included in the hash. The parser programming is done by writing parser code that is compiled into a microcode (a set of hardware configurations). One big problem using this approach is that separate parser code should be written to resolve each and every protocol to be included in the hash. The packet parser does not have infinite resources, as it represents a limited hardware resource. Additional protocols added to the parser consumes more resources. Also, because the parser programming should be done at compile time, it is not possible to dynamically allocate parser resources only for the protocols that are currently in use. Instead, protocols that should be supported at run time should have resources allocated to them at compile time. In addition to these problems, and setting aside hardware resource considerations, adding new protocols to the parser code takes up valuable engineering time by requiring a constant reconfiguring of the system to be able to handle the various new protocols. What is needed is a system, an apparatus, and a method to enable customizable UDP payload hashing, while accounting for many of the constraints and objectives discussed above.

A system, method, apparatus, means, etc. to enable customizable UDP payload hashing is provided for any protocol having a next protocol field. This could be especially valuable for UDP-based protocols (e.g., Network Time Protocol (NTP), Domain Name Service (DNS), Network News Protocol (NNP), Simple Network Management Protocol (SNMP), the Routing Information Protocol (RIP) and the Dynamic Host Configuration Protocol (DHCP), etc.). To configure the generic payload hashing mechanism for UDP packets, the user can select a generic UDP-based protocol that is identified by a destination port. The user also selects a byte range or ranges in a UDP packet that will be used in a hash to create entropy for the UDP packet, allowing for each byte of the payload to be included or excluded in the hash at run time. At run time, based on the destination port and byte ranges specified by the user, the destination port for the generic UDP-based protocol is set, and the hashing control for the byte1-byte32 fields are similarly set.

In operation, during run time, a packet is received, and the packet is suitably parsed by a packet parser. The packet parser determines the identity of the packet when it is received, and the protocol for the packet is identified by the UDP destination port in the UDP header. If the UDP destination port for the packet is listed in the destination port database 128, the system determines which bytes from the packet are to be included in the hash to create entropy for the packet. For example, the system can use offset bytes in the header field of a packet to determine the location of data in the payload field of the packet that can be used to create a hash for the packet. In some examples, the offset bytes can be configured at run time.

Because the system allows the user to include/exclude each byte of the payload in the hash, bytes are exposed to the user and, thereby, allows the system to hash specific bytes for inclusion in the hash. The system also allows the same piece of resource allocated hardware (e.g., parser resource) to be dynamically assigned, which accommodates a variety of different protocols. This effectively avoids parser code being strictly written to account for each protocol sought for inclusion in the hash. It also allows new protocols to be resolved without additional engineering time (discussed above) and, further, avoids having the protocols that need to be supported at run time being allocated to them at compile time.

The true measure of the actual information within a hashed value is entropy. This would determine the actual amount of information contained in the data. This is measured in bits. If the hash is truly random, the number of bits in the hash will be the entropy value. Stated in different terms, a truly random hash function can produce a hash value with the same number of bits as the input data. This means that the information in the input data is preserved in the hash value. However, most hash functions are not truly random. They are designed to be efficient and to produce unique hash values for different input data. As a result, some of the information in the input data may be lost when it is hashed.

The hash label is primarily applicable to Layer 2 services (e.g., virtual leased line (VLL), virtual private LAN service (VPLS), etc.), while the entropy label (EL) is applicable to more general scenarios in which a common way to indicate flows on a wide range of services suitable for load balancing is required.

Turning to FIG. 2, FIG. 2 is a simplified block diagram of a particular non-limiting implementation of the packet parser engine 104 to enable customizable UDP payload hashing. The packet parser engine 104 can include a packet parser header engine 202. In some example implementations, the packet parser engine 104 includes the destination port database 128 and in other implementations, any one or more of these components is provided externally to the packet parser engine 104.

In operation, the packet parser engine 104 can receive and parse packets, determine the packet type, and extract several types of information. After a packet is received, the packet parser header engine 202 can parse the headers of the packet and extract key fields required to make a forwarding decision. One type of information is the UDP destination port of the packet. The destination of the packet is used to identify if the packet is a generic UDP protocol-based packet. If it is a generic UDP based protocol packet, the byte range or ranges in the packet specified by the user will be used in a hash to create entropy for the packet. Stated in slightly different terminology, if the destination port matches specific values, then the byte range or ranges in the packet specified by the user can be used in a hash to create entropy for the packet. For example, a destination port of 4789 would indicate its Virtual eXtensible Local Area Network (VXLAN), and the user could configure bytes of interest for VXLAN packets.

The headers extracted by the packet parser engine 104 depend on the type of packet being processed. For example, for a typical IPv4 packet, the packet parser engine 104 would extract a variety of L2, L3, and L4 headers including the source MAC address, destination MAC address, source IP, destination IP, and corresponding port numbers. The packet parser engine 104 can then determine the VLAN ID of the packet. If the packet arrives on a trunk port, the VLAN-ID can be determined based on the contents of the VLAN header. If the packet arrived on an access port, or arrived untagged, the VLAN ID can be determined based on the port configuration. Once the packet parser engine 104 is aware of the VLAN ID and the ingress interface, the packet parser engine 104 verifies the spanning tree protocol (STP) port state for the receiving VLAN. If the port STP state is ‘discarding’ or ‘learning’, the packet is dropped. If the port STP state is ‘forwarding’, then no action would be taken in this example. As a final ingress check, the packet parser engine 104 can compare the packet against any configured port access control lists (ACLs). If the packet matches a DENY statement, then it will be dropped in this example. If the packet matches a PERMIT statement, or if no port ACL is applied, the packet is passed transparently, together with the extracted information (e.g., including the destination port), to be processed further by the packet entropy engine 106.

Turning to FIG. 3, FIG. 3 is a simplified block diagram of a particular non-limiting implementation of the packet entropy engine 106 to enable customizable UDP payload hashing. The packet entropy engine 106 can include an entropy header engine 302, an entropy payload hashing engine 304, and an entropy creation engine 306. Note that in certain example implementations, one or more of the elements of the packet entropy engine 106 can be located in the packet parser engine 104. In still other example implementations, the packet entropy engine 106 is located within the packet parser engine 104. There is considerable flexibility in such arrangements involving the components in both FIGS. 2 and 3, and all such possibilities are within the broad scope of the present disclosure and its teachings.

The entropy header engine 302 can be configured to determine the byte range or ranges in the UDP packet that will be used in a hash to create entropy for the UDP packet. The byte range or ranges is determined by offsets in an arbitrary header (e.g., the arbitrary header field 612 shown in FIG. 6) within the header of the UDP packet, as further detailed below. The byte range or ranges are set by the user when the user configures the system for a specific flow of packets.

The entropy payload hashing engine 304 can be configured to create the hash using the byte range or ranges in a UDP packet designed by the user for the destination of the packet. By contrast, in some current packet parsers, the UDP source port and a UDP destination port are extracted from a packet. Packet parsers should have a packet processing component allocated at the time of compiling. In the UDP header example, there would be a packet processing component that is used to identify the next protocol, and then the current packet parsers would have a packet processing component for the next tunnel, where those components should be built, evaluated, and allocated at compile time. The entropy header engine 302 can pull additional values from a configurable offset of the packet and allow that user to not have to build those components without requiring a packet processing component to be built for a new protocol. The entropy creation engine 306 can be configured to determine the entropy of the packet based on the hash created by the entropy payload hashing engine 304.

Turning to FIG. 4, FIG. 4 is a simplified block diagram of a particular non-limiting implementation of the entropy header engine 302 to enable customizable UDP payload hashing. The entropy header engine 302 can include a source/destination port engine 402 and a configurable offset engine 404. The source/destination port engine 402 can be configured to determine the source port for a packet and the destination port for the packet. Based on the destination port of the packet being included in the destination port database 128, each byte of the payload of the packet can be included or excluded in the entropy calculation for the packet at run time

The configurable offset engine 404 can be configured to use offset bytes in the header of the packet. This can be used to determine the location in the packet in which the data would reside. This will be used by the entropy payload hashing engine 304 to create a hash for the packet. The hash can then be used by the entropy packet parser engine. It should be pulled or extracted to create the hash that will ultimately be used. In some examples, the packet parser engine 104 and the packet entropy engine 106 work together. The packet parser header engine 202 can use the header of a packet to determine the next protocol, while the packet entropy engine 106 can use the header of the packet to determine the fields from the header that are used to identify data that will be included in the hash and which creates the packet entropy.

The packet parser engine 104 determines the identity of a packet when it is received and the protocols for the packet are identified by the UDP destination port in the UDP header. Once the packet is suitably identified (e.g., based on a next protocol field of the packet) the packet entropy engine 106 determines the bytes from the packet to be included in the hash to create the corresponding entropy. The system affords the network operator the ability to include/exclude each byte of the payload in the hash, as highlighted above.

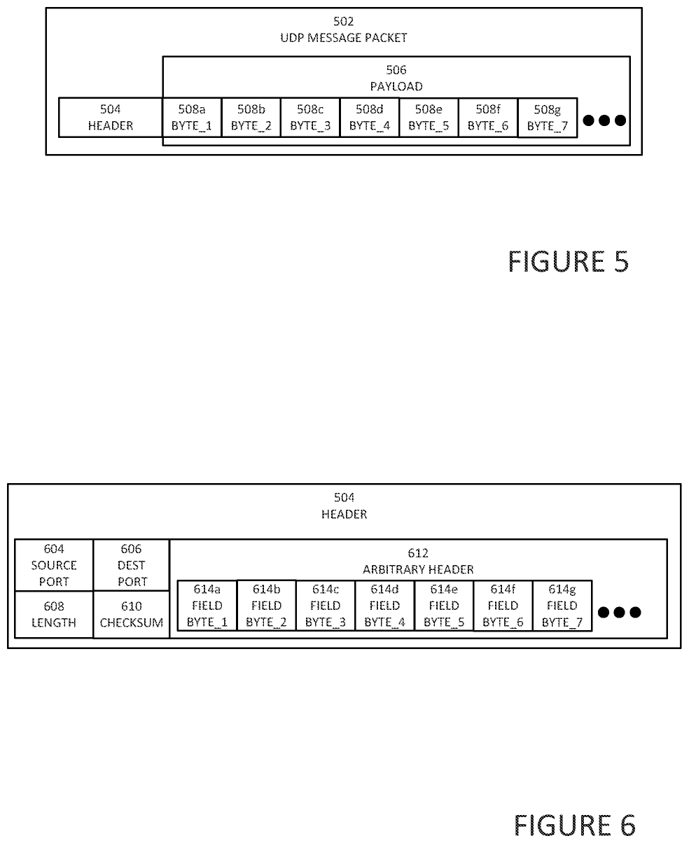

Turning to FIG. 5, FIG. 5 is a simplified block diagram illustrating example details for a particular UDP message packet 502. The UDP message packet 502 can include a header 504 and a payload 506. The payload 506 includes byte portions. For example, as illustrated in FIG. 5, the payload 506 includes a first byte portion 508a (the first group of 8 bits), a second byte portion 508b (the second group of 8 bits), a third byte portion 508c (the third group of 8 bits), a fourth byte portion 508d (the fourth group of 8 bits), a fifth byte portion 508e (the fifth group of 8 bits), a sixth byte portion 508f (the sixth group of 8 bits), a seventh byte portion 508g (the seventh group of 8 bits), etc. Depending on the configuration set by the user, one or more of the first byte portions 508a, the second byte portion 508b, the third byte portions 508c, the fourth byte portions 508d, the fifth byte portions 508e, the sixth byte portions 508f, the seventh byte portions 508g, etc. includes the data that will be used to create the hash that is used to determine the entropy for the UDP message packet 502.

Turning to FIG. 6, FIG. 6 is a simplified block diagram illustrating additional details of the header 504 of the UDP message packet 502 of FIG. 5. In this example, the header 504 can include a source port field 604, a destination port field 606, a length field 608, a checksum field 610, and an arbitrary header field 612. The source port field 604 identifies the port that sent the UDP message packet. The destination port field 606 identifies the destination port for the UDP message packet. The length field 608 specifies the length in bytes of the UDP header and the UDP data (e.g., the payload 506 shown in FIG. 5). The checksum field 610 can be used for error checking of the header and data. The checksum field 610 is optional in some protocols, and it is also mandatory in other protocols.

The arbitrary header field 612 can include field bytes that are used as an offset to identify the byte portions (e.g., byte portions 508a-508g) in the payload of the UDP message packet that will be used to create a hash for the UDP message packet. For example, as illustrated in FIG. 6, the arbitrary header field 612 includes a first field byte portion 614a, a second field byte portion 614b, a third field byte portion 614c, a fourth field byte portion 614d, a fifth field byte portion 614e, a sixth field byte portion 614f, a seventh field byte portion 614g, etc. Each of the field byte portions correspond to a byte portion in the payload for the UDP message packet. For example, the first field byte portion 614a corresponds to the first byte portion 508a, the second field byte portion 614b corresponds to the second byte portion 508b, the third field byte portion 614c corresponds to the third byte portion 508c, the fourth field byte portion 614d corresponds to the fourth byte portion 508d, the fifth field byte portion 614e corresponds to the fifth byte portion 508e, the sixth field byte portion 614f corresponds to the sixth byte portion 508f, the seventh field byte portion 614g corresponds to the seventh byte portion 508g, etc. When the destination for the UDP message packet is determined and, when the destination is in the destination port database, the entropy header engine (illustrated in FIG. 3) uses the field bytes 614a-614g in the arbitrary header field 612 to determine which byte portions in the payload include data to be used to create the hash.

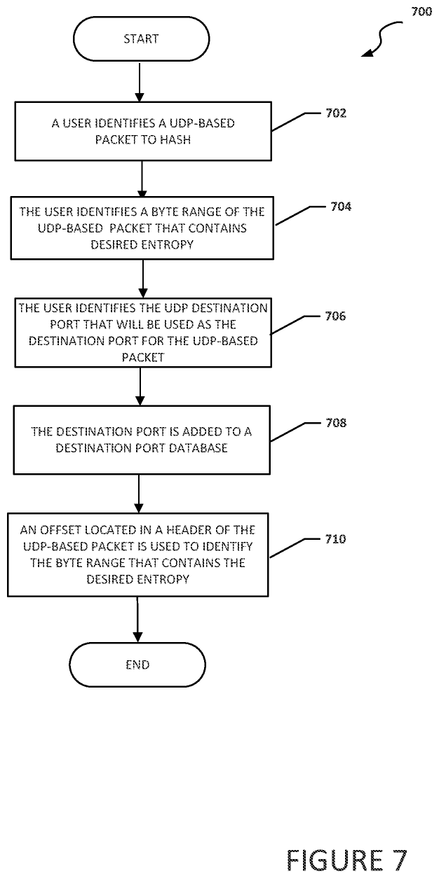

Turning to FIG. 7, FIG. 7 is an example flowchart illustrating operations of a flow 700 to enable customizable UDP payload hashing. In some examples, one or more operations of flow 700 may be performed by the packet parser engine 104, the packet entropy engine 106, the packet parser header engine 202, the entropy header engine 302, the entropy payload hashing engine 304, the entropy creation engine 306, the source/destination port engine 402, and/or the configurable offset engine 404. At 702, a system is configured to identify a UDP-based packet to hash. For example, the system can identify a Domain Name System (DNS) packet, a Simple Network Management Protocol (SNMP) packet, a Routing Information Protocol (RIP) packet, a Dynamic Host Configuration Protocol (DHCP) packet, or some other UDP-based packet to hash. At 704, the system is configured to identify a byte range of the UDP-based packet that contains a desired entropy. Entropy are fields that are known to vary across different flows, but generally stay constant within a singular flow. The idea being a singular flow should follow the same path through the network, but different flows ideally follow along different paths.

In our example, the system can identify bytes 1, 2, and 6-11 as the bytes of the packet to be hashed. At 706, the system identifies the UDP destination port that will be used as the destination port for the UDP-based packet. For example, the system can identify the logical port 122a as the destination port for the UDP-based packets. At 708, the destination port is added to a destination port database. For example, the destination port can be added to the destination port database 128. The reason the destination port is added to the destination port database 128 is so that when a packet is received that is bound for the destination port, the system knows to look at the header of the packet for the offset to determine the packet data to hash, where the hash is used to create the packet entropy. At 710, an offset located in a header of the UDP-based packet is used to identify the byte range that contains the desired entropy. For example, the header of the UDP message packet can include an arbitrary header field, as discussed above. The arbitrary header field can include the field bytes to determine byte portions in the payload of the UDP message packet. These would be included to create the hash for determining the entropy for the UDP message packet.

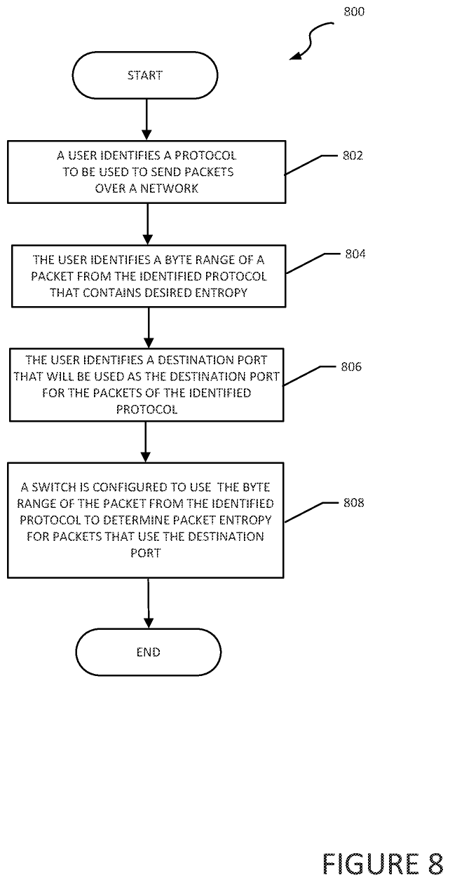

Turning to FIG. 8, FIG. 8 is an example flowchart illustrating operations of a flow 800 to enable a customizable payload hashing for various different types of protocols. In some examples, one or more operations of flow 800 may be performed by the packet parser engine 104, the packet entropy engine 106, the packet parser header engine 202, the entropy header engine 302, the entropy payload hashing engine 304, the entropy creation engine 306, the source/destination port engine 402, and/or the configurable offset engine 404. At 802, a system identifies a protocol to be used to send packets over a network. For example, the user can identify the DNS, the SNMP, the RIP, the DHCP, or some other protocol to send packets over a network. At 804, the system identifies a byte range of a packet from the identified protocol that contains the desired entropy. For example, the system can identify bytes 1, 2, and 6-11 as the bytes of the packet to be hashed. At 806, the system identifies a destination port that will be used as the destination port for the packets of the identified protocol. For example, the system can identify the logical port 122a as the destination port for the packets of the identified protocol. At 808, a switch (e.g., switch 102 of FIG. 1) is configured to use the byte range of the packet from the identified protocol to determine packet entropy for packets that use the destination port. For example, the packet entropy engine 106 discussed above can use the byte range of the packet from the identified protocol to determine packet entropy for packets that use that particular destination port.

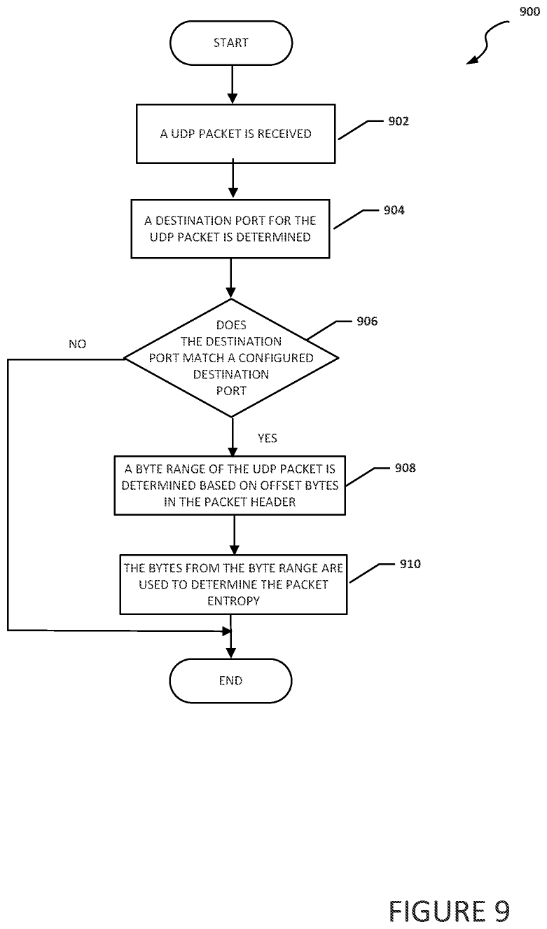

Turning to FIG. 9, FIG. 9 is an example flowchart illustrating operations of a flow 900 to enable customizable payload hashing using a list provisioned within a database. In some examples, one or more operations of flow 900 may be performed by the packet parser engine 104, the packet entropy engine 106, the packet parser header engine 202, the entropy header engine 302, the entropy payload hashing engine 304, the entropy creation engine 306, the source/destination port engine 402, and/or the configurable offset engine 404. At 902, a UDP packet is received. For example, a UDP packet can be received by the packet parser engine 104 in the switch 102 of any of the FIGURES discussed above. At 904, a destination port for the UDP packet is determined (e.g., the packet parser engine determines a destination port for the UDP packet).

At 906, the system determines if the destination port matches a configured destination port. In one example, the architecture uses the destination port database 128 to determine if the destination port matches the configured destination port. Note that this could include multiple protocol fields, not just the ones being detailed herein. Considerable flexibility is provided in this regard as it pertains to the various protocol fields that could be used. If the destination port does not match a configured destination port, the process ends. If the destination port matches a configured destination port, then a byte range of the UDP packet is determined based on offset bytes in the packet header, as shown in 908. For example, the header of the UDP message packet includes an arbitrary header field for this purpose. The arbitrary header field can include the field bytes to determine the byte portions in the payload. At 910, the bytes from the byte range are used to determine the packet entropy. For example, the packet entropy engine can use the byte range of the packet to determine the packet entropy.

Note that there are other example packets, corresponding to different protocols, that could benefit from the same parser engine activity. For example, the packer parser engine could parse packets. For example, other UDP-based protocols could similarly benefit from the capabilities of the packet parser engine. This could include packets associated with NTP, DNS, NNP, SNMP, VxLAN, DHCP, RDMA over Converged Ethernet version 2 (ROCEv2), etc.

Regarding a physical implementation of the switch 102 and its associated components such as the packet entropy engine 106, the entropy header engine 302, etc., any suitable permutation of hardware, software, logic, etc. may be configured based on particular needs and requirements, including the design of a particular network in which the switch 102 is implemented. In one embodiment, the switch 102 may be integrated with the packet parser engine 104 and the packet entropy engine 106. These components can share hardware, software, and processing resources such as the processors 110 and the memory 108. Alternatively, the switch 102 may be implemented separately from the packet parser engine 104 and the packet entropy engine 106 with appropriate communication pathways to the switch 102. In this alternative implementation, the switch 102 may be provided with separate hardware, software, logic resources including one or more processors and memory elements.

In example embodiments, the operations for enabling customizable payload hashing, outlined herein, may be implemented by logic encoded in one or more tangible media, which may be inclusive of non-transitory media (e.g., embedded logic provided in an ASIC, digital signal processor (DSP) instructions, software potentially inclusive of object code and source code to be executed by a processor or other similar machine, etc.). In some of these instances, one or more memory elements (e.g., memory 108) can store data used for the operations described herein. This includes the memory elements being able to store software, logic, code, or processor instructions that are executed to conduct the hashing activities described in this Specification.

The switch 102 and other associated or integrated components can include one or more memory elements (e.g., memory 108, which can include one or more databases as shown) for storing information to be used in achieving operations associated with customizable payload hashing, as outlined herein. These devices may further keep information in any suitable memory element (e.g., random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. The information being tracked, sent, received, or stored in system 100 could be provided in any database, register, table, cache, queue, control list, or storage structure, based on particular needs and implementations, all of which could be referenced in any suitable time frame. Any of the memory or storage options discussed herein should be construed as being encompassed within the broad term ‘memory element’ as used herein in this Specification.

Note that embodiments of the switch 102 may include one or more distinct interfaces, represented by any suitable network interfaces to facilitate communication via the various networks (including both internal and external networks) described herein. Such network interfaces may be inclusive of multiple wired and/or wireless interfaces (e.g., Wi-Fi, WiMax, 3G, 4G, 5G+, white space, 802.11x, satellite, Bluetooth, LTE, GSM/HSPA, CDMA/EVDO, DSRC, CAN, GPS, etc.). Other interfaces represented by network interfaces 26, may include physical ports (e.g., Ethernet, USB, HDMI, etc.), interfaces for wired and wireless internal subsystems, and the like. Similarly, each of the nodes and user equipment (e.g., mobile devices) of system 100 can also include suitable interfaces for receiving, transmitting, and/or otherwise communicating data or information in a network environment.

In the following description, various aspects of the illustrative implementations will be described using terms commonly employed by those skilled in the art to convey the substance of their work to others skilled in the art. However, it will be apparent to those skilled in the art that the embodiments disclosed herein may be practiced with only some of the described aspects. For purposes of explanation, specific numbers, materials, and configurations are set forth in order to provide a thorough understanding of the illustrative implementations. However, it will be apparent to one skilled in the art that the embodiments disclosed herein may be practiced without the specific details. In other instances, well-known features are omitted or simplified in order not to obscure the illustrative implementations.

In the following detailed description, reference is made to the accompanying drawings that form a part hereof, wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). Reference to “one embodiment” or “an embodiment” in the present disclosure means that a particular feature, structure, or characteristic described in connection with the embodiment is included in at least one embodiment. The appearances of the phrase “in one embodiment” or “in an embodiment” are not necessarily all referring to the same embodiment. The appearances of the phrase “for example,” “in an example,” or “in some examples” are not necessarily all referring to the same example.

As used herein, the term “when” may be used to indicate the temporal nature of an event. For example, the phrase “event ‘A’ occurs when event ‘B’ occurs” is to be interpreted to mean that event A may occur before, during, or after the occurrence of event B, but is nonetheless associated with the occurrence of event B. For example, event A occurs when event B occurs if event A occurs in response to the occurrence of event B or in response to a signal indicating that event B has occurred, is occurring, or will occur. Reference to “one example” or “an example” in the present disclosure means that a particular feature, structure, or characteristic described in connection with the embodiment is included in at least one example or embodiment. The appearances of the phrase “in one example” or “in an example” are not necessarily all referring to the same examples or embodiments. Substantial flexibility is provided by the system and method to enable customizable UDP payload hashing in that any suitable arrangements, chronologies, configurations, and timing mechanisms may be provided without departing from the teachings of the present disclosure.

Note that with the examples provided herein, interaction may be described in terms of one, two, three, or more elements. However, this has been done for purposes of clarity and example only. In certain cases, it may be easier to describe one or more of the functionalities by only referencing a limited number of elements. It should be appreciated that the system and method to enable customizable UDP payload hashing and its teachings are readily scalable and can accommodate a large number of components, as well as more complicated/sophisticated arrangements and configurations. Accordingly, the examples provided should not limit the scope or inhibit the broad teachings of the system and method to manage multiple precision time protocol domains and as potentially applied to a myriad of other architectures.

It is also important to note that the operations in the preceding flow diagrams (i.e., FIGS. 7-9) illustrate only some of the possible correlating scenarios and patterns that may be executed, some of these operations may be deleted or removed where appropriate, or these operations may be modified or changed considerably without departing from the scope of the present disclosure. In addition, the timing of these operations may be altered considerably. The preceding operational flows have been offered for purposes of example and discussion. Substantial flexibility is provided in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although the system and method have been illustrated with reference to particular elements and operations, these elements and operations may be replaced by any suitable architecture, protocols, and/or processes that achieve the intended functionality of the system and method.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
receiving a packet;
parsing a header of the packet to:
determine a protocol type for the packet; and
extract information from the packet;
matching a configured protocol field corresponding to the extracted information in the header of the packet to a specified value;
determining a byte range for the packet using the specified value; and
creating entropy for the packet by using data from the byte range.

2. The method of claim 1, wherein the protocol type is user datagram protocol (UDP) for the packet, and wherein a payload type is identified using a destination port in the header.

3. The method of claim 1, wherein the byte range corresponds to a payload byte range and includes non-consecutive bytes.

4. The method of claim 1, further comprising:
accessing a database that includes a plurality of destination ports, wherein the database includes bytes to hash that correspond to each of the destination ports; and
determining which bytes from the packet are included in the hash to create the entropy for the packet.

5. The method of claim 4, wherein the creating includes each byte of a payload of the packet being included or excluded in an entropy calculation for the packet based on a particular destination port of the packet being included in the database.

6. The method of claim 1, further comprising:
determining, based on a plurality of offset bytes in a header field of the packet, a location of data in a payload field of the packet to be used to create the hash for the packet.

7. The method of claim 6, wherein the plurality of offset bytes can be configured at run time for an associated switch that receives the packet.

8. The method of claim 1, wherein the determining of the byte range is determined by an arbitrary header field within the header of the packet.

9. The method of claim 1, wherein the protocol type for the packet is identified by a next protocol field, which corresponds to a destination port field.

10. A method, comprising:
identifying a destination port for a packet based on a configurable next protocol field;
identifying bytes of the packet that are to be used in a hash;
creating entropy for the packet based on the bytes that were identified, wherein an offset within a header of the packet corresponds to the identified bytes of the packet that are to be used in the hash; and
communicating the packet to a next destination based on the destination port.

11. The method of claim 10, wherein the offset corresponds to bytes in a payload of the packet that are to be used in the hash and the offset can be configured at run time for an associated switch that receives the packet.

12. The method of claim 10, further comprising:
using a plurality of offset bytes in a header field of the packet to determine a location of data in a payload field of the packet to be used to create the hash for the packet.

13. The method of claim 10, further comprising:
accessing a database that includes a plurality of destination ports, wherein the database includes bytes to hash that correspond to each of the destination ports; and
determining which bytes from the packet are included in the hash to create the entropy for the packet.

14. The method of claim 13, further comprising:
executing an entropy calculation for the packet based on a particular destination port of the packet being included in the database, wherein the executing includes including or excluding each byte of a payload of the packet.

15. A switch, comprising:
memory for storing executable instructions;
a packet entropy engine; and
at least one processor to execute the instructions, wherein the packet entropy engine is configured to:
determine a protocol type for the packet; and
extract information from the packet;
match a configured protocol field corresponding to the extracted information in the header of the packet to a specified value;
determine a byte range for the packet using the specified value; and
create entropy for the packet by using data from the byte range.

16. The switch of claim 15, wherein the byte range corresponds to a payload byte range and includes non-consecutive bytes.

17. The switch of claim 16, wherein the protocol type is user datagram protocol (UDP) for the packet, and wherein a payload type is identified using a destination port in the header.

18. The switch of claim 15, further comprising:
a database that includes a plurality of destination ports, wherein the database includes bytes to hash that correspond to each of the destination ports, and wherein each byte of a payload of the packet is included or excluded in an entropy calculation for the packet based on a particular destination port of the packet being included in the database that includes the plurality of destination ports.

19. The switch of claim 15, further comprising:
using a plurality of offset bytes in a header field of the packet to determine a location of data in a payload field of the packet to be used to create the hash for the packet.

20. The switch of claim 15, wherein a protocol type for the packet is identified by a next protocol field, which corresponds to a destination port field.
